(19) United States
(12) Patent Application Publication
(10) Pub. No.: US 2010/0126059 A1
(43) Pub. Date: May 27, 2010

(54) Water emulsion production apparatus

(75) Inventors: Keijiro Shiode, Hachioji-shi (JP); Tadashi Taguchi, Takayama-shi (JP); Masao Miyamoto, Kawasaki-shi (JP); Hironori Kijima, Tokyo (JP)

Correspondence Address: COOPER & DUNHAM, LLP, 30 Rockefeller Plaza, 20th Floor, NEW YORK, NY, 10112, US

(73) Assignee: Yamato Ecology Corporation

(21) Appl. No.: 12/657,478

(22) Filed: Jan. 20, 2010

Related U.S. Application Data
(63) Continuation of application No. PCT/JP2008/063208, filed on Jul. 23, 2008.

(30) Foreign Application Priority Data
Jul. 23, 2007 (JP) 2007-191346

(51) Int. Cl. C10L 1/32; B01F 5/08

(52) U.S. Cl. 44/301; 366/176.1

(57) ABSTRACT

A water emulsion production apparatus including a water emulsion container, a pump for applying a pressure to an oil-water mixture, an injection nozzle injecting the oil-water mixture supplied through the pump into the water emulsion container, and a collision plate which is arranged opposed to the injection nozzle in the water emulsion container and with which the oil-water mixture injected through the injection nozzle is caused to collide.

### CROSS REFERENCE TO RELATED APPLICATIONS

This is a Continuation Application of PCT Application No. PCT/JP2008/063208, filed Jul. 23, 2008, which was published under PCT Article 21(2) in Japanese.

This application is based upon and claims the benefit of priority from prior Japanese Patent Application No. 2007-191346, filed Jul. 23, 2007, the entire contents of which are incorporated herein by reference.

### BACKGROUND OF THE INVENTION

1. Field of the Invention

The present invention relates to an apparatus for producing a water emulsion such as a water emulsion fuel.

2. Description of the Related Art

A water emulsion fuel of a water-in-oil type (W/O type) is known to be combusted based on the following principle. That is, when water emulsion fuel is sprayed into a combustor, oil droplets of the fuel is heated and combusted. At the same time, water particles contained in the oil droplets are heated by radiation heat. The temperature of the water particles reaches a boiling point and the water particles are micro-exploded, which secondarily atomize the surrounding oil droplets. Thus, the fuel is instantaneously atomized into ultrafine particles, and the contact area of the fuel with air increases to cause nearly complete combustion to be achieved. This inhibits unburnt carbon and NOx from being generated in combustion exhaust gas. Furthermore, the increase in the contact area with the air enables a reduction in excess air required for combustion. This provides significant energy saving effect.

Conventionally, in order to produce a two-phase water emulsion fuel containing a fuel (heavy oil, light oil, kerosene, BDF, or gasoline) and water, a method is mainly used in which a mixture of the fuel and water is mechanically stirred with a screw, a mixer, shearing, or an ultrasonic homogenizer to disperse water particles (disperse phase) in the fuel (continuous phase).

For example, Jpn. Pat. Appln. KOKAI Publication No. 2006-111666 describes an emulsion fuel production apparatus comprising an injection nozzle to inject a mixture containing a fuel and water in the circumferential direction of a stirring container and to form a first swirling flow in the mixture in the stirring container, and a stirring blade to form, below the first swirling flow, a second swirling flow with a smaller diameter than the first swirling flow.

Water is particularly insoluble in a fuel such as light oil and A-type heavy oil which are significantly different from water in density, and thus, the water is easily subjected to phase separation. The method of mechanically stirring the mixture comprising fuel and water has a disadvantage that water particles with a wide particle size distribution ranging from about 1 μm to about 30 μm are formed in the fuel and large water particles aggregate and settle out in a short time, resulting in phase separation. The water emulsion fuel phase-separated in such a manner cannot be used as a fuel particularly during start-up. Therefore, an emulsifier is commonly used to prevent the mixture from undergoing phase separation into the fuel and water.

The apparatus using mechanical stirring as described above is large and complicated, leading to high cost of the apparatus. Furthermore, owing to the use of the emulsifier, the apparatus is disadvantageous in terms of cost-effectiveness. Moreover, even with use of the emulsifier, phase separation into fuel and water may occur in a short time. Thus, it is actually difficult to install the stirring apparatus in line with the combustor.

On the other hand, Jpn. Pat. Appln. KOKAI Publication No. 6-42734 describes an emulsion production apparatus comprising a water injection nozzle to inject pressurized water located at one end of a mixing/stirring chamber and a fuel injection nozzle to inject pressurized fuel located at the other end of the mixing/stirring chamber opposed the water injection nozzle.

However, misty water and misty fuel injected through the two opposite nozzles are very unlikely to collide with each other. Thus, it is expected to be impossible to produce water emulsion in which fine water particles are dispersed in the fuel.

### BRIEF SUMMARY OF THE INVENTION

An object of the present invention is to provide a water emulsion production apparatus which has a simple configuration and can be reduced in size, and which makes it possible to produce a water emulsion with fine water particles dispersed in oil in a low cost without using an emulsifier, and which can be installed in line with a combustor or the like.

A water emulsion production apparatus according to the present invention comprises: a water emulsion container; a pump for applying a pressure to an oil-water mixture; an injection nozzle injecting the oil-water mixture supplied through the pump into the water emulsion container; and a collision plate which is arranged opposed to the injection nozzle in the water emulsion container and with which the oil-water mixture injected through the injection nozzle is caused to collide.

### BRIEF DESCRIPTION OF THE SEVERAL VIEWS OF THE DRAWINGS

FIG. 1A is a diagram showing the configuration of a water emulsion fuel production apparatus according to a first embodiment of the present invention, and FIG. 1B is a plan view of FIG. 1A;

FIG. 2A is a diagram showing the water emulsion fuel production apparatus according to a second embodiment of the present invention, and FIG. 2B is a cross-sectional view along the line B-B′ in FIG. 2A;

FIG. 3 is a diagram showing the water emulsion fuel production apparatus according to a third embodiment of the present invention;

FIG. 4A is a diagram showing the water emulsion fuel production apparatus according to a fourth embodiment of the present invention, and FIG. 4B is a plan view of FIG. 4A;

FIG. 5 is a diagram showing the water emulsion fuel production apparatus of a dispersal arrangement type according to a fifth embodiment of the present invention;

FIG. 6 is a diagram showing the water emulsion fuel production apparatus of a dispersal arrangement type according to a modification of the fifth embodiment of the present invention; and

FIG. 7 is a diagram showing the water emulsion fuel production apparatus of a one-pass type according to a sixth embodiment of the present invention.

### DETAILED DESCRIPTION OF THE INVENTION

A theory relating to a water emulsion production apparatus according to the present invention will be described.

As understood from the description in Background Art, if fine water particles can be dispersed in fuel, stable water emulsion can, in theory, be produced without the use of an emulsifier (surfactant). The theoretical rationale for this can be approximately described based on the Stokes equation (1) expressing the movement velocity (settling velocity) of particles:

Vp=a²×(ρ₀−ρ₁)×G/18×ρ₀×υ (1)

where Vp is the movement velocity (m/sec) of particles, (a) is the particle size (of water) (m), ρ₀ is the density (kg/m³) of the continuous phase, ρ₁ is the density (kg/m³) of the disperse phase, υ is the kinematic viscosity (m²/sec) of the continuous phase, and G is the gravitational acceleration (9.8 m/sec²).

Equation (1) shows that a smaller water particle size (a) enables a reduction in the movement velocity (settling velocity) of the particles, which suppresses phase separation over an extended time period. In the present invention, the target water particle size is 1 μm or less (submicron), preferably 500 nm or less, more preferably 100 nm or less.

In order to form fine water particles, water droplets should be collapsed. A collapse mechanism for water droplets is generally considered as follows. When water droplets are injected into a fluid, the tips of water droplets tend to be shaped like spheres owing to surface tension. However, when the water droplets push aside the stationary fluid, a stagnation point is created in a central portion of the fluid. The pressure in this portion becomes higher than that in the other portions. The pressure can be determined based on the Bernouli theorem (2):

P=(σV²/2)^{1/2} (2)

When the pressure P becomes higher than the surface tension of water droplets, the water droplets start to deform from the stagnation point and finally collapse into smaller water particles. Here, the surface tension of water forming a free surface is 72 dyne/cm (surface tension of light oil is estimated to be about 30 dyne/cm). For example, if water particles with a particle size of 1 μm are present in light oil, the internal pressure P of the water particles is 408×10⁴ dyne/cm², which is higher than the pressure of surroundings by 4 bar. Therefore, application of a pressure equal to or higher than the internal pressure causes the water droplets to be destroyed into fine water particles.

The water emulsion production apparatus according to the present invention pressurizes and injects an oil-water mixture through an injection nozzle so that the mixture is collided with a collision plate to destroy water droplets into finer water particles. Then, the kinetic energy of the injected oil-water mixture can be converted into pressure at a high efficiency close to 100%. As a result, submicron water particles can be formed. Water emulsion containing such fine water particles is prevented from undergoing phase separation over an extended time period even without containing an emulsifier. Thus, the water emulsion production apparatus according to the present invention can be arranged in line with a combustor, for example. Preferably, the operations of injecting an oil-water mixture through the injection nozzle such that the mixture is collided with the collision plate are repeated. Then, finer water particles can be efficiently formed, and water emulsion can be maintained over an extended time period. Furthermore, the water emulsion production apparatus according to the present invention has a simple configuration and can thus be reduced in seize. Even if the capacity of the apparatus is increased, the apparatus is prevented from being complicated. Consequently, the water emulsion production apparatus according to the present invention is very cost-effective.

A first embodiment of the present invention will be described below with reference to the drawings.

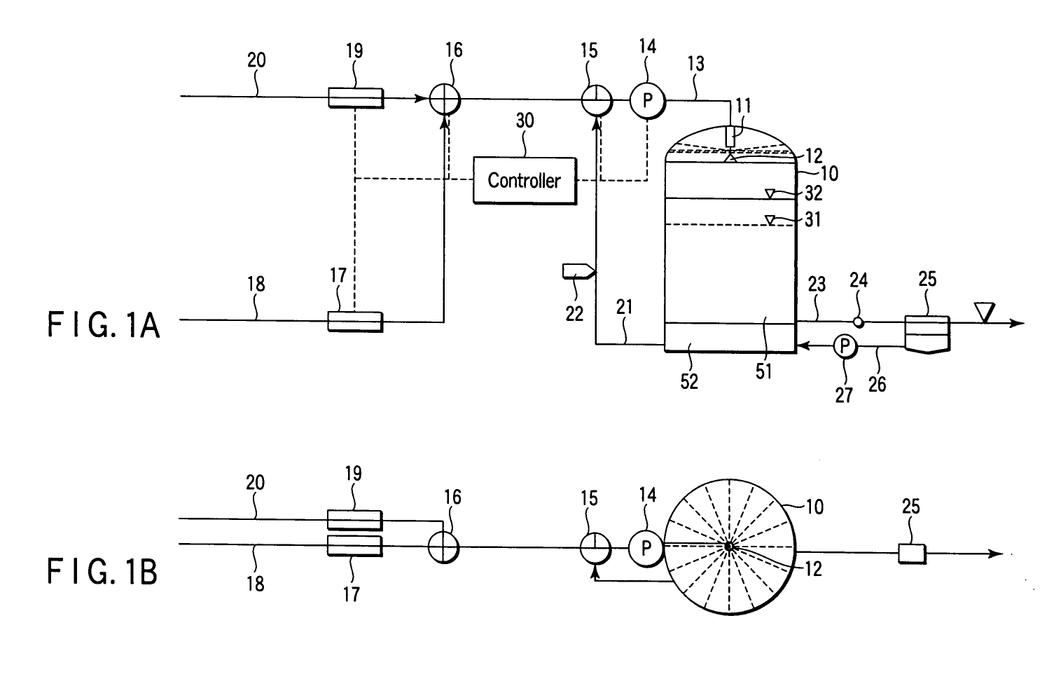

FIG. 1A is a diagram of a water emulsion fuel production apparatus according to the first embodiment of the present invention. FIG. 1B is a plan view of FIG. 1A. The water emulsion fuel production apparatus is installed beside a boiler, a cogeneration system, a ship or car engine, or the like to supply water emulsion fuel in line to the combustor. The basic structure of the water emulsion fuel production apparatus according to the present invention remains almost unchanged regardless of the combustor in which the water emulsion fuel production apparatus is installed.

A water emulsion container 10 made of stainless steel is configured to store produced water emulsion fuel. The water emulsion container 10 is, for example, cylindrical. The shape of the water emulsion container 10 is not limited to a cylinder but may be a rectangular column. The water emulsion container 10 may be a vertical type or horizontal type. The capacity of the water emulsion container 10 can be set to any value depending on the combustor used so that the value ranges from a small value of about one litter to a large value for ships and electric generators.

An injection nozzle 11 is inserted in the top of the water emulsion container 10 to inject a high-pressure fuel-water mixture toward the interior of the water emulsion container 10. The injection nozzle 11 has a nozzle diameter of, for example, 0.1 mm to 1.0 mm. The mounting position of the nozzle and the shape, direction, and number of nozzle holes can be appropriately adjusted in accordance with the intended use. Although not shown, a nozzle configured to inject oil only and a nozzle configured to inject water only may be arranged.

In the water emulsion container 10, a collision plate 12 is supported opposite the injection nozzle 11 so that the injected fuel-water mixture is collided with the collision plate 12. The distance between the nozzle hole of the injection nozzle 11 and the collision plate 12 is set to 1 mm to 50 mm. As the distance is shortened, a pressure drop of the injected fuel-water mixture can be suppressed. The shape of the collision plate 12 is not particularly limited, and a flat shape, a conical shape, or a spherical shape, for example, may be used. A flat collision plate 12 is advantageous for converting the kinetic energy of the injected fuel-water mixture to a pressure. A conical or spherical collision plate 12 is advantageous for efficient dispersion of water droplets in fuel.

A mixture supply line 13 is connected to the injection nozzle 11. A pump 14 and a switching valve 15 are arranged in the mixture supply line 13. The mixture supply line reaches a mixing tank 16. The mixing tank 16 is provided with a mixer to mix fuel and water. Then, the fuel-water mixture is pressurized with the pump 13 to a pressure of 5 MPa to 40 MPa. If the water emulsion container 10 has a large capacity, the fuel-water mixture may be pressurized with the pump 13 to a pressure of 50 MPa or more.

A fuel supply line 18 provided with a fuel supply solenoid valve 17 and a water supply line 20 provided with a water supply solenoid valve 19 are connected upstream from the mixing tank 16.

A circulation line 21 is connected to the water emulsion container 10. Thus, the water emulsion fuel in the water emulsion container 10 can be circulated to the injection nozzle 11 through the switching valve 15 and the pump 14. A stirrer (not shown) may be arranged in the way of the circulation line 21.

Moreover, an air valve 22 configured to charge air may be arranged in the way of the circulation line 21 as required. Charging of air through the air valve 22 makes it possible to produce water emulsion fuel containing atomized air as well as atomized water. When such water emulsion fuel is sprayed into a combustor, an action that air dissolved in the water emulsion fuel is instantaneously expanded to diffuse the fuel is also obtained. Thus, fuel droplets which are easily combusted with oxygen in air can be utilized, so that more nearly complete combustion can be achieved. This leads to improved combustion efficiency and cleaned exhaust gas.

Charging of air through the air valve can be employed not only to produce water emulsion fuel but also to modify only the fuel. That is, if the fuel is modified so as to contain atomized air by charging air through the air valve into the fuel and injecting the pressurized fuel through the injection nozzle to collide with the collision plate, the air is expanded in the combustor and fuel droplets which are easily combusted with oxygen in air can be utilized. This leads to improved combustion efficiency and cleaned exhaust gas.

Alternatively, with respect to a liquid other than fuel (such as water, mixed water, washing water, and sterile water), if a method of charging air into the liquid through the air valve and injecting the pressurized liquid through the injection nozzle so as to collide with the collision plate is employed, a liquid containing atomized air can be produced.

A water emulsion fuel supply line 23 is connected downstream from the water emulsion container 10 and to a combustor such as a boiler or a car engine. A pressure regulating valve 24 and a trap 25 are arranged in the water emulsion fuel supply line 23. The bottom of the trap 25 is connected to the bottom of the water emulsion container 10 via a return pipe 26. A pump 27 is arranged in the return pipe 26.

The pump 14, the switching valve 15, the mixing tank 16, the fuel supply solenoid valve 17, and the water supply solenoid valve 19 are desirably controlled by a controller 30. Data processed by the controller 30 such as flow rates of fuel and water is transmitted to an administrative server (not shown) as required.

The water emulsion fuel production apparatus according to the present invention may be of an integral type in which the components are integrated together or a separate type in which the components are separated from one another. Alternatively, in a simpler configuration, the fuel supply solenoid valve 17, the fuel supply line 18, the water supply solenoid valve 19, and the water supply line 20 may be omitted from the water emulsion fuel production apparatus. In this case, water emulsion fuel is produced by feeding a fuel-water mixture of a predetermined mixing ratio into the water emulsion fuel container 10, and performing injection and collision while circulating the fuel-water mixture via the circulation line (and a stirrer arranged in the way of the circulation line as required).

Now, the operation of the water emulsion fuel production apparatus will be described. The fuel in the fuel supply line 18, the flow rate of which is controlled by the fuel supply solenoid valve 17, and the water in the water supply line 20, the flow rate of which is controlled by the water supply solenoid valve 19, are supplied to the mixing tank 15 at a predetermined flow ratio. In the mixing tank 15, the fuel and the water are mixed by the mixer. The fuel-water mixture is fed from the mixing tank 15 to the pump 14, where the mixture is pressurized to a pressure of 5 MPa to 40 MPa. The pressurized mixture is injected through the injection nozzle 11 and collided with the collision plate 12.

In the present invention, the injection nozzle 11 applies kinetic energy higher than the internal pressure of water droplets to an injected flow of the fuel-water mixture. When the injected flow is collided with the collision plate 12, the kinetic energy of the injected flow is converted into pressure. Thus, the water particles (disperse phase) are atomized into ultrafine particles, which are dispersed in the fuel (continuous phase). The size of the water particles has a correlation with the injection pressure. That is, as the pressure is higher, finer water particles can be formed. The present invention enables to easily produce water particles of particle size of 1 μm or less (submicron) by using the means of colliding the injected flow of the fuel-water mixture with the collision plate 12.

The upper space in the water emulsion container 10 is used as a mixing section where the injected fuel and water are mixed together. In the mixing section, a film of the sprayed fuel is formed around the atomized water particles resulting from the collision with the collision plate 12. Thus, water emulsion fuel in which the disperse phase of the water particles is dispersed in the continuous phase of the fuel is quickly produced. The produced water emulsion fuel is stored in a storage section 51. If no phase separation has occurred, almost only the water emulsion fuel is stored in the water emulsion container 10. However, if a fuel-water mixture containing micelle colloid of water particles is formed, it retains in a retention section 52 located under the storage section 51. The water emulsion fuel containing large-sized water particles retained in the retention section 52 is not suitable for use in the start-up of the combustor. Thus, the water emulsion fuel in the retention section 52 is not supplied to the combustor. Note that, although no partition is arranged in the water emulsion container 10 in FIGS. 1A and 1B, a partition may be arranged in the water emulsion fuel container 10 if turbulent flow of the liquid is caused by vibration or the like.

It is desirable to repeat an operation comprising switching the switching valve 15 to cause the water emulsion fuel in the water emulsion container 10 to be injected through the injection nozzle 11 via the pump 14 so that the fuel is collided with the collision plate 12. That is, a single collision of the injected flow of the fuel-water mixture with the collision plate 12 may result in formation of water particles of particle size 1 μm or more. Furthermore, as time elapses, even submicron water particles may be formed into micelle colloids of particle size 1 μm or more.

In contrast, repetition of circulation of the water emulsion fuel causes the water particles in the water emulsion fuel to be more significantly atomized. The circulation line 21 may be continuously or intermittently used except during the new supply of fuel or water as described below. As a result, phase separation into fuel and water can be prevented over an extended time period.

The water emulsion fuel in the water emulsion fuel container 10 is supplied in line to the combustor such as a boiler or a car engine through the fuel supply line 23. The trap 25 is arranged as required if the distance between the water emulsion fuel container 10 and the combustor is so long that the micelle colloids may settle out. Micelle colloids trapped by the trap 25 are returned to the retention section 51 of the water emulsion fuel container 10 via the return pipe 26. Thus, in start-up, possible ignition failure is prevented that is caused by supplying the water emulsion fuel containing water particles formed into micelle colloid to the combustor.

A supply start sensor 31 and a supply stop sensor 32 may be arranged in the water emulsion fuel container 10. When the amount of water emulsion fuel in the water emulsion fuel container 10 is decreased because of the use in the combustor, the fuel supply start sensor 31 is turned on. As a result, the switching valve 15 is switched to open the fuel supply solenoid valve 17 and the water supply solenoid valve 19. Thus, new supplies of fuel and water are mixed in the mixing tank 16. The fuel-water mixture is then injected through the injection nozzle 11 via the switching valve 15 and the pump 14, and collided with the collision plate 12. Consequently, new water emulsion fuel is generated and stored in the water emulsion fuel container 10. When the amount of water emulsion fuel in the water emulsion fuel container 10 is increased to reach the level of the supply stop sensor 32, new supplies of fuel and water are stopped.

Then, combustion tests were carried out using a boiler comprising an A-heavy oil burner so that water was heated. By way of an example, the water emulsion fuel production apparatus according to the present invention was used to combust water emulsion fuel prepared in a ratio of A-heavy oil to water of 8:2 for two hours. In a comparative example, only A-heavy oil was used as fuel and combusted for two hours. The combustion tests were carried out to compare boiler efficiency.

When boiler output is Q1 and the amount of heat supplied is Q2, the boiler efficiency η is expressed by:

η=Q1/Q2.

Here, Q1 and Q2 are defined as follows:

Q1=Qw(Wt2−Wt1),

where Qw is an amount of water supplied [L/min], Wt1 is an inlet water temperature, and Wt2 is an outlet water temperature.

Q2=Hu×Gf,

where Hu is a quantity of heat generated by A-heavy oil, and Gf is a fuel flow rate; for the water emulsion fuel in the present example, the actual fuel flow rate is multiplied by 0.8.

The fuel flow rate of the A-heavy oil in the comparative example was 9.572 L/H on an average. The inlet water temperature Wt1 (average value) was 16.75° C., whereas the outlet water temperature Wt2 (average value) was 65.75° C. In this case, Q1/Q2 is as follows:

$$\begin{matrix}Q 1 \text{/} Q 2 = Qw ( 65.75 - 16.75 ) / Hu \times 9.572 \\ = 5.119 Qw \text{/} Hu .\end{matrix}$$

The flow rate of the water emulsion fuel in the example was 9.786L/H on an average. The inlet water temperature Wt1 (average value) was 18.4° C., whereas the outlet water temperature Wt2 (average value) was 64.0° C. In this case, Q1/Q2 is as follows:

$$\begin{matrix}Q 1 \text{/} Q 2 = Qw ( 64.0 - 18.4 ) / Hu \times 9.786 \times 0.8 \\ = 5.825 Qw \text{/} Hu .\end{matrix}$$

The above results indicate that the use of the water emulsion fuel had increased efficiency by 5.825/5.119=1.137, that is, about 14%, compared to the use of the A-heavy oil.

Furthermore, the effect of reducing carbon dioxide, NOx and hydrocarbon (HC) was confirmed, which is known as the advantage of the use of water emulsion fuel.

Similarly, combustion tests were carried out for an engine using water emulsion fuel prepared in a ratio of light oil to water of 8:2 or light oil only was used. Then, the water emulsion fuel was determined to be effective for increasing the efficiency and reducing carbon dioxide, NOx and hydrocarbon (HC).

In the above-described examples, the apparatus according to the present invention is used to produce water emulsion fuel containing heavy oil and water or light oil and water. However, the present invention may be used for various applications. For example, for water emulsion fuel containing heavy oil and water or light oil and water, the mixing ratio of water may be increased up to 50%. Additionally, it is possible to produce not only water emulsion fuel containing heavy oil and water or light oil and water but also water emulsion fuel containing heavy oil, water, and glycerin or light oil, water, and glycerin. Glycerin is generated as a by-product of BDF fuel and cannot presently be effectively utilized, and is thus incinerated. However, the apparatus according to the present invention enables glycerin to be effectively utilized in water emulsion fuel containing glycerin. Since glycerin is soluble in water, a mixture of fuel and (water+glycerin) may be supplied. Moreover, not only heavy oil and light oil but also various oil components may be used to produce water emulsion.

Now, water emulsion fuel production apparatuses according to other embodiments of the present invention will be described.

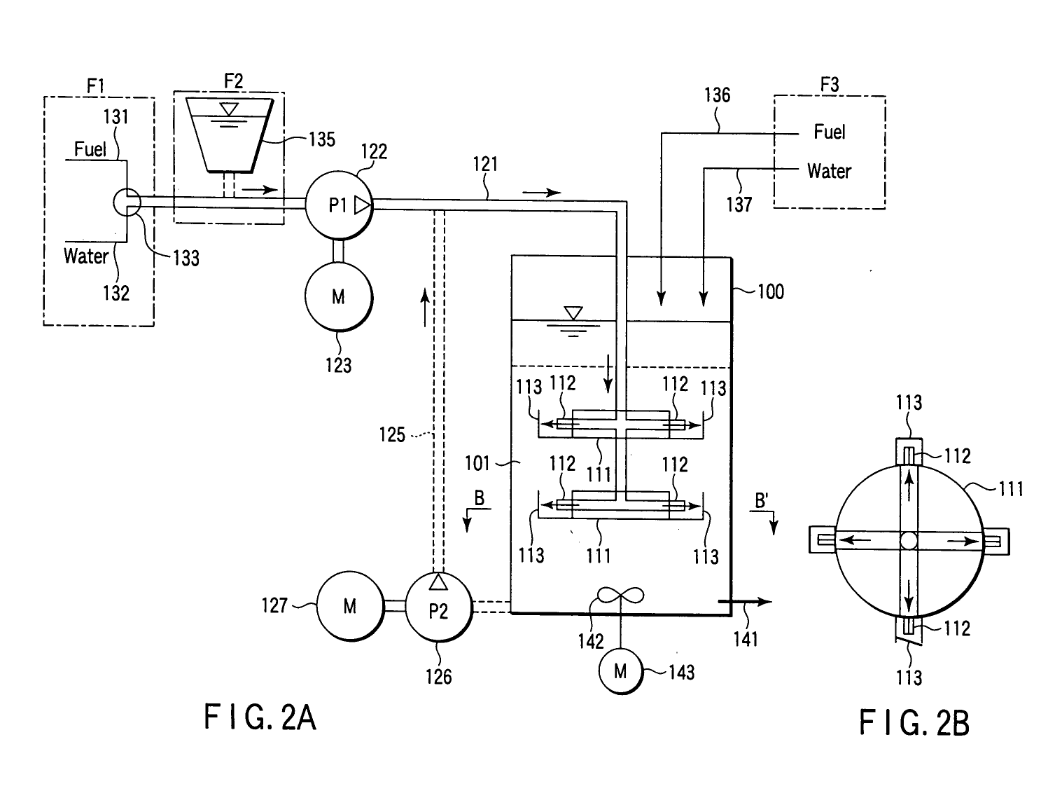

FIG. 2A is a diagram showing the configuration of a water emulsion fuel production apparatus according to a second embodiment. FIG. 2B is a cross-sectional view taken along the line B-B′ in FIG. 2A.

Produced water emulsion fuel is stored in a storage section 101 inside a water emulsion fuel container 100. Injection nozzles 112 supported by a support 111 and collision plates 113 located opposite the respective injection nozzles 112 are arranged in a liquid in the water emulsion fuel container 100. As shown in FIG. 2B, four sets of the injection nozzle 112 and the collision plate 113 are arranged on the circumference at intervals of 90°. Furthermore, two units each of which includes the four sets of the injection nozzle 112 and the collision plate 113 are arranged one above the other. In this manner, a total of eight sets of the injection nozzle 112 and the collision plate 113 are arranged to improve the efficiency of produce of water emulsion fuel. Furthermore, as shown in the lower part of FIG. 2B, one or more of the collision plates 113 may be slightly inclined to the injection nozzle 112. Then, a swirling flow may be generated in the liquid in the water emulsion fuel container 100, which serves to achieve proper stirring.

FIG. 2A shows three fuel and water supply systems F1, F2, and F3 optionally used, which will be described below.

The injection nozzles 112, arranged in the liquid in the water emulsion fuel container 100, are connected to a mixture supply line 121. If the first or second fuel and water supply system F1 or F2 is used, a high-pressure pump 122 is arranged upstream from the mixture supply line 121. The high-pressure pump 122 is driven by a motor 123.

If the first fuel and water supply system F1 is used, fuel from a fuel supply line 131 and water from a water supply line 132 are mixed in a mixing tank 133, and then, the fuel-water mixture is pressurized by the high-pressure pump 122 and injected through the injection nozzles 112 via the mixture supply line 121, and the mixture is collided with the collision plates 113 to thereby produce water emulsion fuel.

If the second fuel and water supply system F2 is used, fuel and water are pre-mixed in a tank 135, and the fuel-water mixture is pressurized by the high-pressure pump 122 and injected through the injection nozzles 112 via the mixture supply line 121, and the mixture is collided with the collision plates 113 to thereby produce water emulsion fuel.

On the other hand, if the third fuel and water supply system F3 is used, a circulation line 125 through which the liquid in the water emulsion fuel container 100 is circulated is connected to the mixture supply line 121. A high-pressure pump 126 is arranged in the circulation line 125. The high-pressure pump 126 is driven by a motor 127. If the third fuel and water supply system F3 is used, fuel from a fuel supply line 136 and water from a water supply line 137 are metered and fed directly into the water emulsion fuel container 100, and the fuel-water mixture is pressurized by a high-pressure pump 126 and injected through the injection nozzles 112 via the mixture supply line 121, and the mixture is collided with the collision plates 113 to thereby produce water emulsion fuel. This cyclic operation is continued until water emulsion fuel suitable for combustion is produced.

Note that, even when the first or second fuel and water supply system F1 or F2 is used, it is possible to use the high-pressure pump 126 arranged in the circulation line 125 together with the high-pressure pump 122 arranged upstream from the mixture supply line 121.

The water emulsion fuel produced by the above-described operation is supplied to the combustor such as an engine or a boiler through a water emulsion fuel supply line 141. When the operation for manufacturing water emulsion fuel is stopped, a stirring apparatus 142 is preferably used to stir the liquid in the water emulsion fuel container 100 so as to maintain the mixing ratio of the water emulsion fuel constant. The stirring apparatus 142 is driven by a motor 143. Although a screw is used as the stirring apparatus 142 in FIG. 2A, a low-pressure pump may be used instead of the screw.

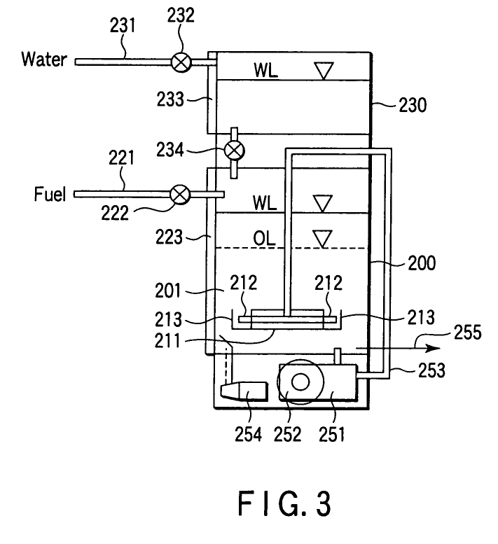

FIG. 3 is a diagram showing the configuration of a water emulsion fuel production apparatus according to a third embodiment of the present invention. In the apparatus, valve and pump operations for supplying fuel and water are manually performed. The apparatus is used to produce a small amount of water emulsion fuel and is inexpensive.

Produced water emulsion fuel is stored in a storage section 201 inside a water emulsion fuel container 200. Injection nozzles 212 supported by a support 211 and collision plates 213 located opposite the respective injection nozzles 212 are arranged in a liquid in the water emulsion fuel container 200. A fuel supply line 221 provided with a manual valve 222 is connected to the water emulsion fuel container 200. A scale 223 is attached to a side surface of the water emulsion fuel container 200. The user supplies fuel up to a predetermined fuel line (OL) while looking at the scale 223.

A water tank 230 is arranged at the top of the water emulsion fuel container 200. A water supply line 231 provided with a manual valve 232 is connected to the water tank 230. A scale 233 is attached to a side surface of the water tank 230. The user supplies fuel up to a predetermined water line (WL) while looking at the scale 233. The water tank 230 is connected to the water emulsion fuel container 200 via a manual valve 234.

A high-pressure pump 251 driven by a motor 252 is arranged at the bottom of the water emulsion fuel container 200. The user switches on and operates the high-pressure pump 251, while opening the manual valve 234 to supply water little by little. When the level in the water emulsion fuel container 200 reaches the predetermined water line (WL), the user closes the manual valve 234.

The liquid in the water emulsion fuel container 200 is pressurized by the high-pressure pump 251. The pressurized liquid is injected through the injection nozzles 212 via the circulation line 253 and collided with the collision plates 213. As a result, water emulsion fuel is produced. This cyclic operation is continued until water emulsion fuel suitable for combustion is produced. The produced water emulsion fuel is supplied to the combustor such as a boiler through a water emulsion fuel supply line 255.

Even when the operation for manufacturing water emulsion fuel is stopped, the water emulsion fuel can be used by using a low-pressure pump 254 for stirring to suck, eject, and stir the liquid in the water emulsion fuel container 200.

A setting retardant may be used to retard the settling of water particles. Thus, the stirring carried out by the low-pressure pump 254 may be reduced or eliminated. The settling retardant may be waste engine oil or waste edible oil. The amount of settling retardant added is in the range of 0.2% to 1% of the amount of water emulsion fuel and is set in accordance with the type of fuel and the mixing ratio of water. For example, if A-heavy oil is used in a water mixing ratio of 30%, the addition amount of the settling retardant is set to about 0.5%. The settling retardant may be fed directly into the water emulsion fuel container 200 or fed into a fuel tank in advance.

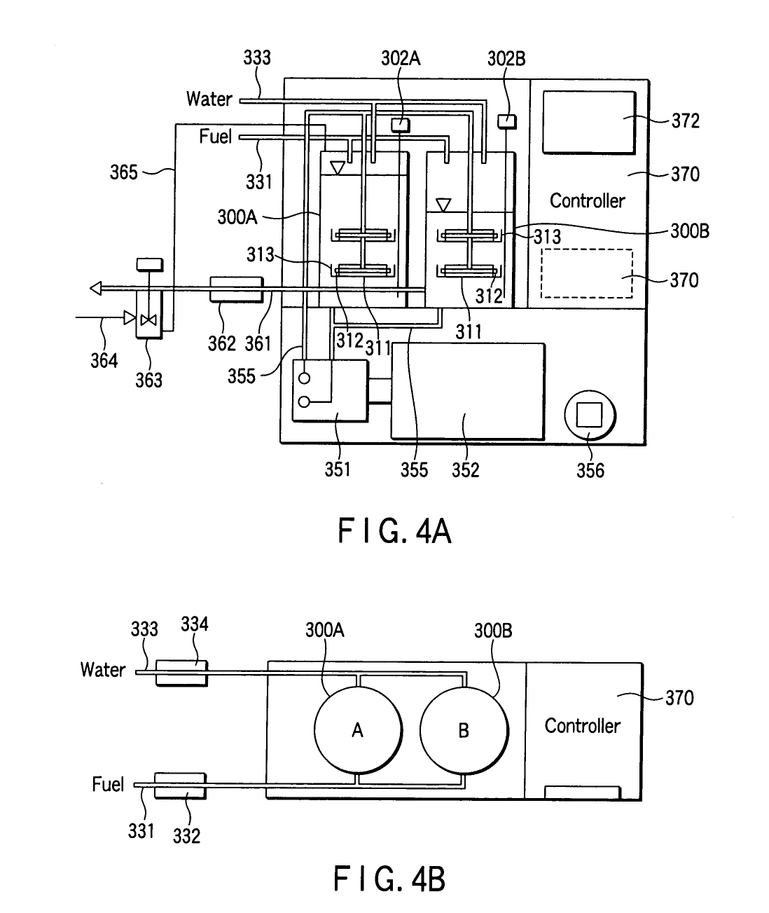

FIG. 4A is a diagram showing the configuration of a water emulsion fuel production apparatus according to a fourth embodiment of the present invention. FIG. 4B is a plan view of FIG. 4A. The apparatus is of a tandem type including two water emulsion fuel containers. The water emulsion fuel containers are automatically controlled so as to be switched for operation. The apparatus is installed beside, for example, a boiler that uses a large amount of water emulsion fuel.

Produced water emulsion fuel is stored in a storage section inside each of two water emulsion fuel containers 300A and 300B. Injection nozzles 312 supported by a support 311 and collision plates 313 located opposite the injection nozzles 312 are arranged in a liquid in each of the water emulsion fuel containers 300A and 300B. Similarly to FIG. 2A, two units each of which includes the injection nozzles 112 and the collision plates 113 are arranged one above the other.

Fuel is fed from a fuel supply line 331 through a flow meter 332 to one of the water emulsion fuel containers. Water is fed from a fuel supply line 333 through a flow meter 334 to one of the water emulsion fuel containers. The liquid levels in the water emulsion fuel containers 300A and 300B are monitored by respective level sensors 302A and 302B.

A high-pressure pump 351 connected to a circulation line 355 for the water emulsion fuel containers 300A and 300B is arranged below the water emulsion fuel containers 300A and 300B. The high-pressure pump 351 is driven by a motor 352. The liquid in the water emulsion fuel container is pressurized by the high-pressure pump 351. The pressurized liquid is injected through the injection nozzles 312 via the circulation line 355 and is collided with the collision plates 313. As a result, water emulsion fuel is produced. The water emulsion fuel in the water emulsion fuel containers 300A and 300B is stirred and uniformly mixed by a low-pressure pump 356. For simplification, a line through which the low-pressure pump 356 sucks and ejects the water emulsion fuel from the water emulsion fuel containers is omitted from FIG. 4A. A stirrer such as a screw may be used instead of the low-pressure pump 356.

The water emulsion fuel in the water emulsion fuel containers 300A and 300B is supplied to the combustor such as an engine or a boiler through the water emulsion fuel supply line 361, the flow meter 362, and a trap 363 with a stirrer. If the water emulsion fuel is supplied to the engine, return fuel from the engine is returned to the trap 363. The water emulsion fuel trapped by the trap 363 is returned to the water emulsion fuel containers 300A and 300B through a return line 366.

Various components are controlled by a controller 370. The controller 370 includes an inverter 371. Operation conditions for the controller 370 are input into an operation panel 372.

An example of the operation of a water emulsion fuel production apparatus according to the present embodiment will be described.

First, fuel is supplied to the water emulsion fuel container 300A. When the level sensor 302A detects that the fuel reaches the predetermined level, the fuel supply is stopped. At the same time, the high-pressure pump 351 is driven to start supplying water. The start and stop of the fuel supply and water supply is subjected to sequence control by the controller 370.

With the liquid in the water emulsion fuel container 300A circulated, the liquid pressurized by the high-pressure pump 351 is injected through the injection nozzles 312. The liquid is collided with the collision plates 313 to thereby produce water emulsion fuel. Note that, if viscous fuel such as C-heavy oil is used or the water emulsion fuel production apparatus is installed beside a furnace, a large-sized engine, and a large-sized boiler which are not affected by a large particle size of water, the liquid in the water emulsion fuel container need not be always circulated.

The operation for manufacturing water emulsion fuel is alternately performed in the two water emulsion fuel containers 300A and 300B. Emulsion fuel is also fed alternately from the two water emulsion fuel container 300A and 300B to the combustor.

The operation and management of pumps, motors, solenoid valves, and inverters, and measurements and data transfers by flow meters and pressure gauges are controlled by the controller 370. Various data is transmitted to an administrative server as required.

In FIGS. 4A and 4B, two water emulsion fuel containers are used. However, three or more water emulsion fuel containers may be used as required. Furthermore, although not shown in the drawings, the line may be switched to a line that uses normal fuel in case of emergency and when the apparatus is stopped for maintenance.

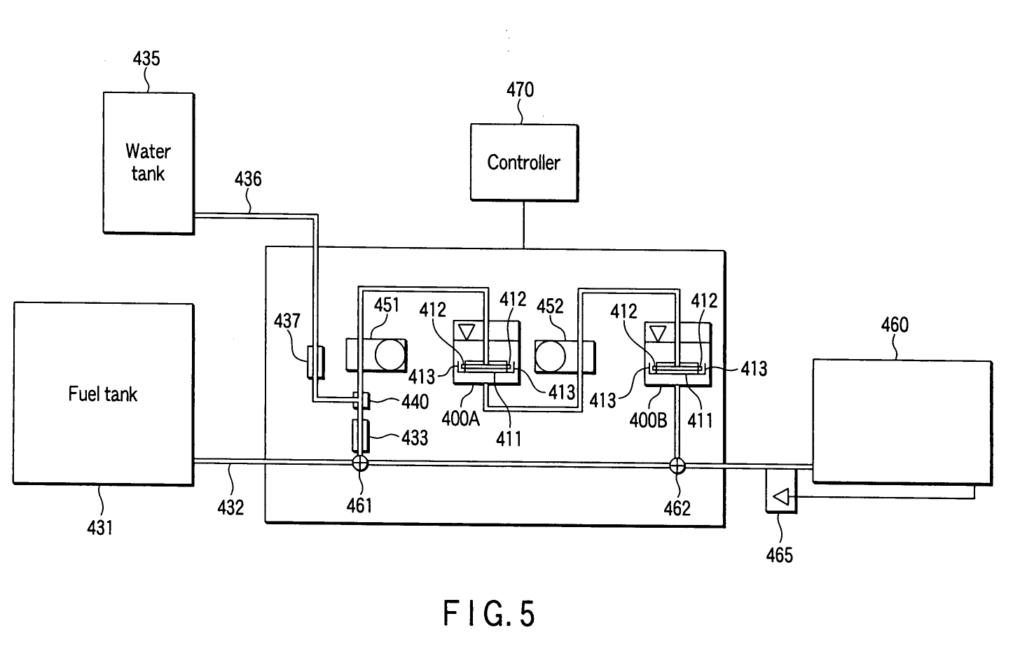

FIG. 5 is a diagram showing the configuration of a distributively arranged water emulsion fuel production apparatus according to a fifth embodiment of the present invention. In the apparatus, distributively arranged two water emulsion fuel containers 400A and 400B are connected in line. The apparatus is installed beside a ship engine or the like which has no sufficient space to install the integral apparatus shown in FIGS. 4A and 4B and which uses a relatively large amount of fuel.

The fuel in a fuel tank 431 may be supplied directly to the ship engine or the like through a fuel supply line 432 and bypass switching valve 461 and 462, so that the fuel can be combusted in the conventional manner.

When water emulsion fuel is produced, the bypass switching valves 461 and 462 are switched. The fuel in the fuel tank 431 is fed to a mixing tank 440 through the fuel supply line 432, the bypass switching valve 461, and a flow meter 433. The water in a water tank 435 is fed to the mixing tank 440 through a water supply line 436 and a flow meter 437. In the in-line arrangement, the amount of water fed from the water tank 435 is adjusted in proportion to the amount of fuel fed from the fuel tank 431. The fuel-water mixture mixed in the mixing layer 440 is passed a high-pressure pump 451 for the first pass, the water emulsion fuel container 400A for the first pass, a high-pressure pump 452 for the second pass, and the water emulsion fuel container 400B for the second pass. Injection nozzles 412 supported by a support 411 and collision plates 413 located opposite the injection nozzles 412 are arranged in the liquid in each of the water emulsion fuel containers 400A and 400B. The fuel-water mixture is pressurized by the high-pressure pump 451 and injected through the injection nozzles 412 in the water emulsion fuel container 400A, and the mixture is collided with the collision plates 413 to thereby produce water emulsion fuel. Moreover, the water emulsion fuel exited the water emulsion fuel container 400A is pressurized by the high-pressure pump 451 and injected through the injection nozzles 412 in the water emulsion fuel container 400A, and the mixture is collided with the collision plates 413 to thereby produce water emulsion fuel containing finer particles.

The produced water emulsion fuel is fed through the bypass switching valve 462 and a trap 465 to a combustor 460, where the fuel is combusted. If the combustor 460 is an engine, return fuel is returned to the trap 465.

The operation and management of pumps, motors, solenoid valves, and inverters and measurements and data transfers by flow meters and pressure gauges are controlled by a controller 470.

Fuel such as C-heavy oil having a high viscosity and a high specific gravity is used for large-sized ship engines. Even after the produce of the emulsion, the fuel can be used without problems provided that water particles settle out relatively slowly and have a particle size of about 5 to 10 μm. Thus, water emulsion fuel can be efficiently produced by connecting the plurality of water emulsion fuel containers 400A and 400B in line.

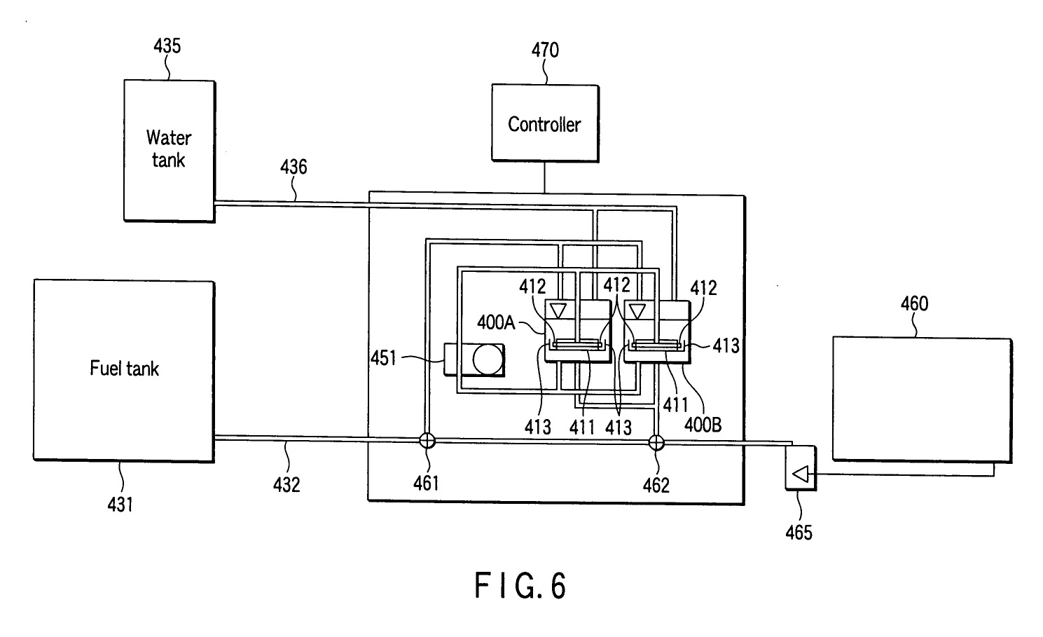

FIG. 6 is a diagram showing the configuration of a distributively arranged water emulsion fuel production apparatus according to a modification of the fifth embodiment of the present invention. The apparatus has the configuration similar to that shown in FIG. 4 except that water emulsion fuel is produced by circulating the liquid in the distributively arranged two water emulsion fuel containers 400A and 400B using the high-pressure pump 451.

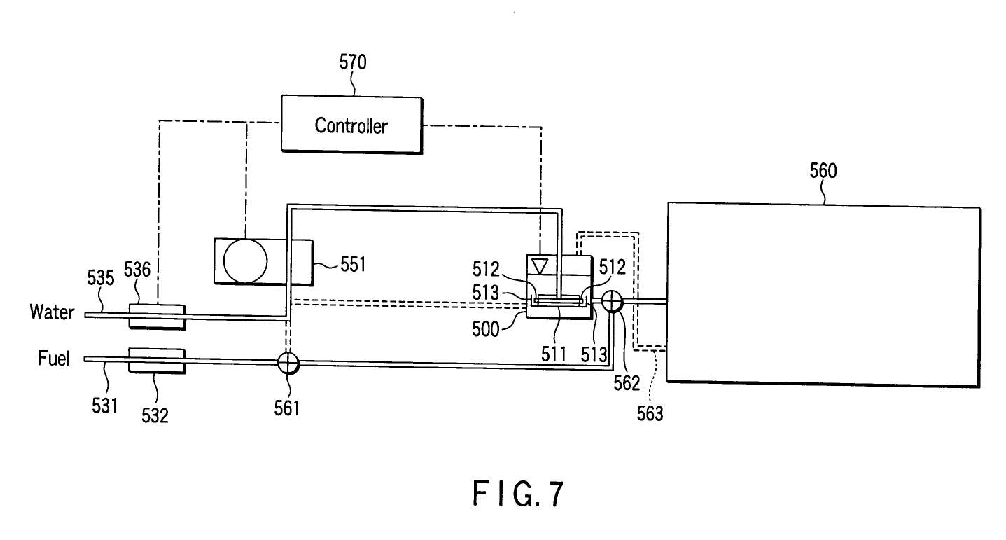

FIG. 7 is a diagram showing the configuration of a one-pass type water emulsion fuel production apparatus according to a sixth embodiment of the present invention. This apparatus produces water emulsion fuel by only one injection of a fuel-water mixture. The apparatus is installed beside a combustor such as an engine, a boiler, and a furnace which are not affected by a relatively nonuniform size of water particles in water emulsion fuel. The apparatus is installed as close to the combustor as possible, and produced water emulsion fuel is immediately combusted in the combustor.

Fuel may be supplied directly to a combustor 560 through a fuel supply line 531, a flow meter 532, and bypass switching valves 561 and 562, so that the fuel can be combusted in the conventional manner.

When water emulsion fuel is produced, the bypass switching valves 561 and 562 are switched. Fuel is supplied through the fuel supply line 531, the flow meter 532, and the bypass switching valve 561. Water is supplied through a water supply line 535 and a flow meter 536. The fuel-water mixture is pressurized by a high-pressure pump 551 and is fed to a water emulsion fuel container 500. Injection nozzles 512 supported by a support 511 and collision plates 513 located opposite the injection nozzles 512 are arranged in the liquid in the water emulsion fuel container 500. The fuel-water mixture pressurized by the high-pressure pump 551 is injected through the injection nozzles 512 in the water emulsion fuel container 500, and collided with the collision plates 513 to thereby produce water emulsion fuel. The produced water emulsion fuel is fed through the bypass switching valve 562 to the combustor 560, where the fuel is combusted. The operation and management of pumps, motors, solenoid valves, and inverters and measurements and data transfers by flow meters and pressure gauges are controlled by a controller 570.

A circulation line 521 may be connected to the water emulsion fuel container 500. Moreover, return fuel from the engine may be returned to the water emulsion fuel container 500 through a return line 563.

What is claimed is:

1. A water emulsion production apparatus comprising:
a water emulsion container;
a pump for applying a pressure to an oil-water mixture;
an injection nozzle injecting the oil-water mixture supplied through the pump into the water emulsion container; and
a collision plate which is arranged opposed to the injection nozzle in the water emulsion container and with which the oil-water mixture injected through the injection nozzle is caused to collide.

2. The water emulsion production apparatus according to claim 1, further comprising a circulation line to cause a water emulsion stored in the water emulsion container to be injected through the injection nozzle via the pump.

3. The water emulsion production apparatus according to claim 1, further comprising a mixing tank to mix oil with water upstream from the pump.

4. The water emulsion production apparatus according to claim 1, further comprising an air valve through which air is injected into the circulation line.

5. The water emulsion production apparatus according to claim 1, wherein a pressure of the pump is 5 MPa or more, and a distance between a nozzle hole of the injection nozzle and the collision plate is between 1 mm and 50 mm.

6. The water emulsion production apparatus according to claim 1, wherein the injection nozzle and the collision plate are arranged above a liquid level in the water emulsion container.

7. The water emulsion production apparatus according to claim 1, wherein the injection nozzle and the collision plate are arranged in a liquid in the water emulsion container.

8. The water emulsion production apparatus according to claim 1, wherein a plurality of water emulsion containers are switchably arranged.

9. The water emulsion production apparatus according to claim 1, wherein a plurality of water emulsion containers are arranged in line.

10. A method for producing a water emulsion comprising injecting a pressurized oil-water mixture through an injection nozzle, and causing the mixture to collide with a collision plate.
